(19) United States
(12) Patent Application Publication
(10) Pub. No.: US 2020/0000075 A1
(43) Pub. Date: Jan. 2, 2020

(54) Fishing Sinker Assembly

(71) Applicant: Peter John Welsh, Papakura Auckland (NZ)

(72) Inventor: Peter John Welsh, Papakura Auckland (NZ)

(73) Assignee: Catch Industries, Ponsonby 1144 Auckland (NZ)

(21) Appl. No.: 15/990,758

(22) Filed: May 28, 2018

(51) Int. Cl. A01K 95/00

(52) U.S. Cl. CPC A01K 95/005

(57) ABSTRACT

A fishing sinker assembly that is used in combination with a fishing pole that maintains and direct an extendable length of fishing line to which bait is attached the assembly is secured to an end or section of baited fishing line that is placed into a body of water during fishing. The assembly causes the baited fishing to sink below the surface of the water to an optimal depth, and can attract fish. The assembly includes a two-section containing member and a two-section enclosing member. The containing member's first section has cavities into each of which is inserted a wedge. The wedge can be made of a variety of materials or a fish attracting substance. The second section functions as a cover over the cavities and wedges a cover over the cavities and wedges. The enclosing member's two sections are placed on and over the containing member and are made of an impact-resistant or impact-absorbing material to protect against inadvertent contact between the assembly and a vessel.

### TECHNICAL FIELD

The invention generally pertains to fishing equipment, and more particularly to a fishing sinker assembly that facilitates the sinking of a baited fishing line below the surface of a body of water, and protects a vessel from damage resulting from inadvertent contact of the assembly on the vessel.

### BACKGROUND ART

Fishing sinkers are used to send a baited hook on a fishing line towards the bottom of a body of water. A fishing sinker is typically made from a mass of lead with a hole therethrough. The hole allows the sinker to be secured to the line. Other means of attachment are also known such as an eyelet that extends from the mass.

Adding or subtracting mass from the line is accomplished by adding or removing individual sinkers, which can be time consuming and difficult. Sinkers are also commonly made of hard, heavy materials, for example lead, steel, brass or bismuth so as to have the required density and durability required for their use.

However, when fishing from a vessel, it is possible for the sinker to impact against the hull or other areas of the vessel, especially while the line is placed in or removed from a body of water. The impact of the sinker often results in damage to the sinker and/or chipping or denting of the vessel.

Padding can be attached to either the vessel or the sinker in order to prevent or reduce damage resulting from a contact between them, however it can be difficult to keep the padding in place in a marine environment. It is found that the padding can easily be dislodged by strong currents or by drag forces caused by movement of the vessel or the sinker through water.

A search of the prior art did not disclose any literature or patents that read directly on the claims of the instant invention. However, the following U.S. patents are considered related:

| PATENT NO. | INVENTOR | ISSUED |
|---|---|---|
| 4,019,275 | Ruppe | Apr. 26, 1977 |
| 4,649,663 | Strickland | Mar. 17, 1987 |
| 2016/0302401 | Grundy | Oct. 20, 2016 |

The U.S. Pat. No. 4,019,275 patent discloses a fishing sinker with skeletal fins projecting therefrom that serve to engage the floor of the fishing bed and maintain the sinker in its cast position.

The U.S. Pat. No. 4,649,663 patent discloses a slip sinker slidably mounted on a line. The sinker consists of a length of pliable plastic material extending through and secured to an elongated tapered body. The line extends through the plastic sleeve and is free to move within the sinker. The plastic sleeve extends completely through the sinker on opposite sides thereof so that the line can freely move through the plastic liner.

The 2016/0302401 publication discloses a fishing sinker that includes a sinker body with a bore formed through it. A unidirectionally displaceable wedge is received in the bore with a passage for a line formed through the wedge. A friction reducing sleeve is located between the bore and the wedge and is fast with the sinker body. The sinker is designed to make it difficult for fish to feel any jerking or hesitation on the line as they take a baited hook so that they are not immediately alerted to the presence of fishing tackle.

For background purposes and indicative of the art to which the invention relates, reference may be made to the following remaining patents found in the patent search.

| PATENT NO. | INVENTOR | ISSUED |
|---|---|---|
| 2,250,038 | Sink | Jul. 22, 1941 |
| 3,096,599 | Baron | Jul. 9, 1963 |
| 3,852,907 | Haught | Dec. 10, 1974 |
| 5,406,739 | Lu | Apr. 18, 1995 |
| 5,588,248 | Cornell, Jr. et al | Dec. 31, 1996 |

### DISCLOSURE OF THE INVENTION

A fishing sinker assembly that is used in combination with a fishing pole that maintains and directs an extendable length of fishing line with a bait hook at a distal end. The assembly is secured to an end or a section of baited fishing line that is placed in a body of water. The assembly causes the baited line to sink below the surface of the water to an optimal depth, and to attract fish to the bait on the line.

The assembly includes an inner two-section containing member and an outer two-section enclosing member with both containing member's sections having a bulbous shape. The containing member's first section has multiple cavities each of which is preferably triangular shaped. Into each cavity is placed a wedge which is also preferably triangular shaped to correspond to the shape of the cavity. The wedge can be made of a variety of materials including metal, plastic, a composite material or a fish attracting substance, and functions as a weight to force the assembly and baited fishing line to sink to an optimal depth and/or to attract fish to the baited line. The function is typically dependent on the material the wedge is made of. Additionally, the wedge can be made of, or include, a material that illuminates, such as a phosphorescent material, which produces a glowing object underwater that attracts fish to the baited line. When the wedge is made of an illuminated material the containing member and enclosing member must both be transparent or translucent. For other applications the members can be any color or combination of colors.

The assembly's enclosing member also has a first section and a second section, each of which is placed onto and over the respective first and second section of the containing member. The enclosing member's sections are made of an impact-resistant or impact-absorbing material such as rubber, silicone, plastic, foam or a composite material. The impact-resistant or impact-absorbing material prevents damage that results when the assembly is used from a vessel and inadvertently contacts the vessel when the assembly is placed into or removed from a body of water. The material is also resilient which allows the sections to slightly expand when being placed on the containing member and then contract to create a secure friction fit.

To use the assembly, wedges are placed within the cavities in the containing member's first section and the containing member's second section is placed on the first section. The two sections of the enclosing member are then placed on and over the containing member. The assembly is then secured to a baited fishing line. A central aperture, either with or without a side-oriented slot, extends through the entire assembly and facilitates the securement of the assembly to the line. Once the assembly is secured to the baited fishing line, the assembly and line are placed into a body of water and allowed to sink to an optimal depth.

In view of the above disclosure, the primary object of the invention is to provide a fishing sinker that causes a baited fishing line to sink in a body of water, attract fish to the baited line, and protect a vessel and the assembly from damage resulting from inadvertent contact between the assembly and the vessel.

In addition to the primary object, it is also an object of the invention to provide a fishing sinker that:
is easy to use,
can be used with any type of fishing pole and/or fishing line,
can be used for freshwater and saltwater fishing,
can be used for fishing from a vessel, a dock, or any other location,
is durable and long-lasting,
can attract fish, thereby increasing the number of fish that are caught,
can be sold as an aftermarket product or with a fishing pole and/or fishing line,
is easy to clean,
is cost effective from both a manufacturer's and fisher's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an exploded view of a fishing sinker assembly including a containing member, an enclosing member and at least one wedge.

FIG. 2 is an elevational side view of the fishing sinker assembly.

FIG. 3 is an elevational view of the assembly secured to a fishing line extending from a fishing pole.

FIG. 4 is an elevational side view of the assembly containing member's first section.

FIG. 5 is a top plan view of the assembly containing member's first section, showing cavities separated by dividing walls, and an opening in a lower inner surface of each cavity.

FIG. 6 is a bottom plan view of the assembly containing member's first section showing openings in a lower surface.

FIG. 7 is an elevational side view of the assembly containing member's second section with a domed outer surface.

FIG. 8 is a top plan view of the assembly containing member's second section with a central aperture and side slot extending from the aperture.

FIG. 9 is an elevational side view of the assembly enclosing member's first section.

FIG. 10 is an elevational side view of the assembly enclosing member's second section.

FIG. 11 is a top plan view of the assembly enclosing member's second section with a central aperture.

FIG. 12 is an elevational side view of the assembly wedge.

### BEST MODE FOR CARRYING OUT THE INVENTION

The best mode for carrying out the invention is presented in terms that disclose a preferred embodiment of a fishing sinker assembly (assembly 10). A fishing sinker is device that causes a baited fishing line to sink below the surface of a body of water to an optimal depth. Without a fishing sinker, a fishing line with bait attached to a hook on a distal end, will typically float on the surface of a body of water as a result of the relating low-weight of the line, hook and bait. This makes fishing difficult since fish often will not see or smell bait floating on the surface, and certain fish prefer not to swim to the surface. The assembly 10 provides a solution to this problem by providing a fishing sinker that is quickly and easily secured to a fishing line to facilitate the sinking of a baited line to a below surface depth. Additionally, the assembly 10 can include a fish attracting substance that will draw fish to the baited line, and since the assembly 10 has outer sections made of an impact-resistant or impact-absorbing material, when the assembly is used from a vessel, the assembly 10 will protect itself as well as the vessel from damage that can occur when the assembly 10 inadvertently contacts the vessel as the assembly is placed into or removed from a body of water.

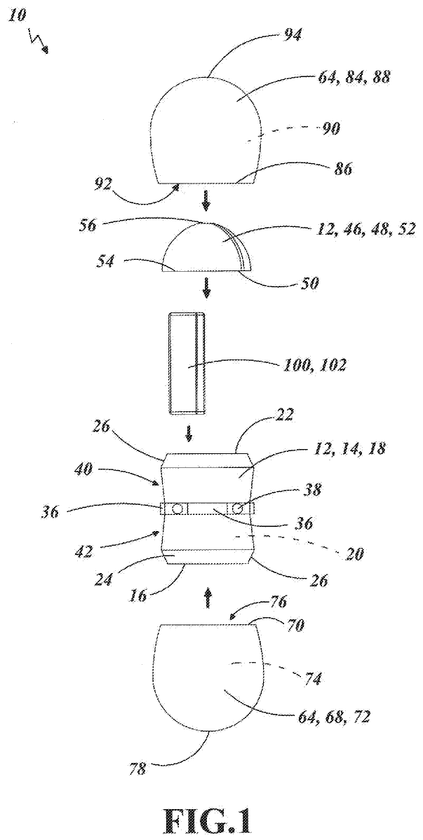

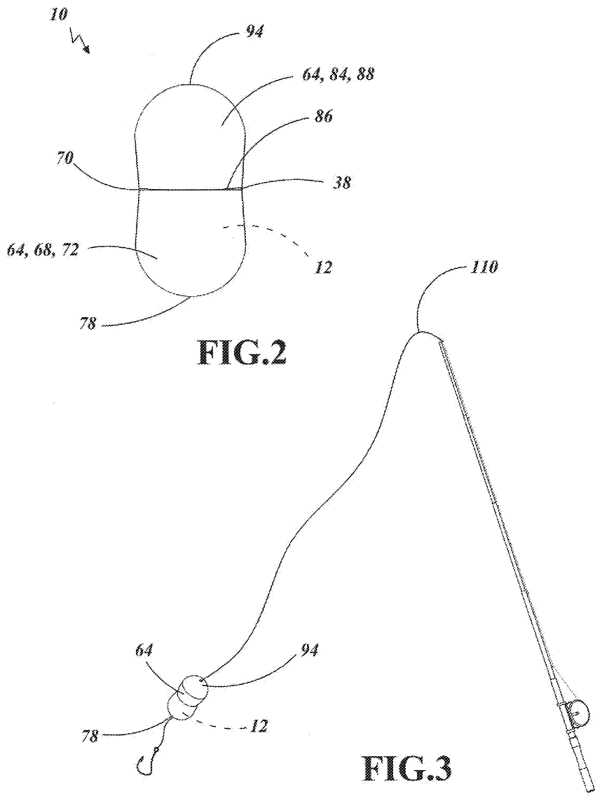

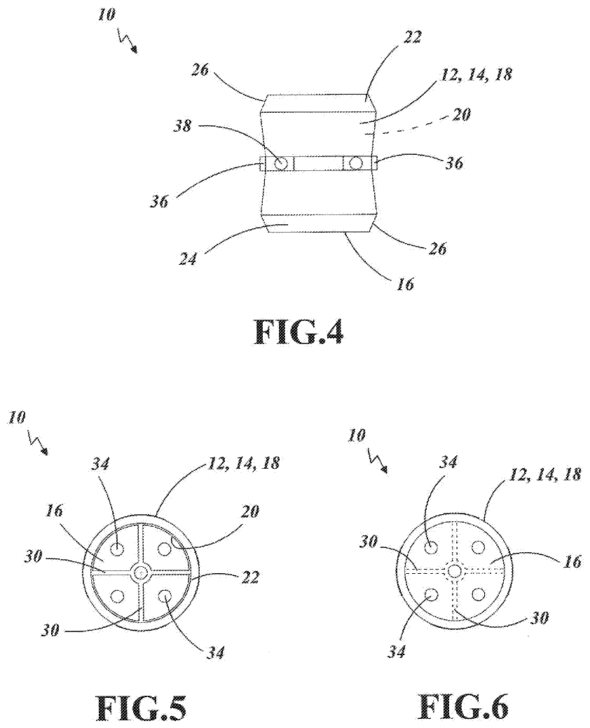

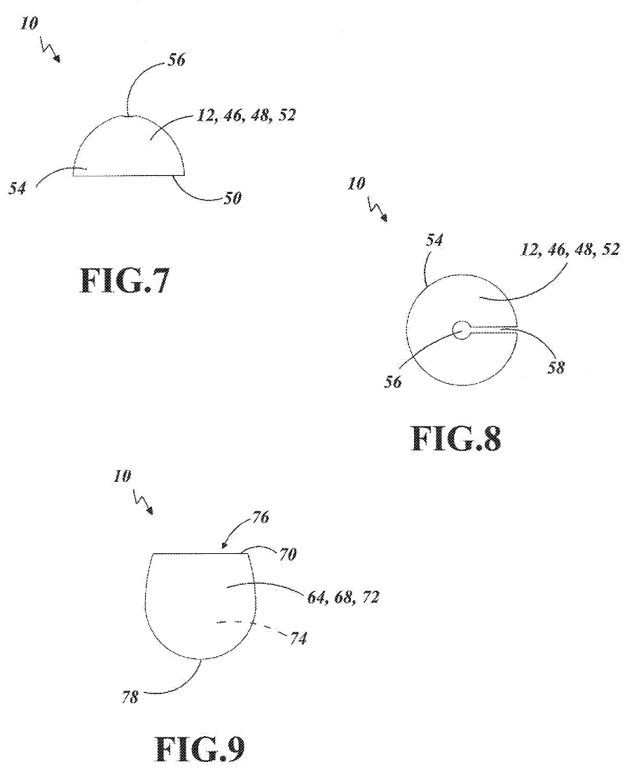

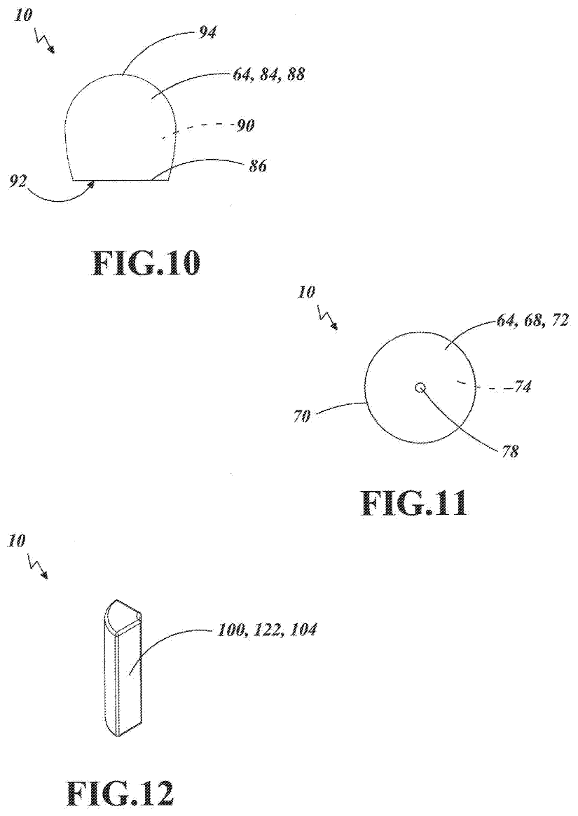

The assembly 10, as shown in FIGS. 1-12, is comprised of the following major elements: a containing member 12, an enclosing member 64, and wedges 100. The containing member 12, as shown in FIGS. 4, 5 and 6, includes a first section 14 having a lower surface 16, an outer surface 18, an inner surface 20, an upper perimeter edge 22, and a lower perimeter edge 24. The first section 14 can be made of a variety of materials such as plastic, metal or a composite material, with plastic preferred which allows the first section 14 to be fabricated by an injection mold process or 3-D printing. The first section is preferably substantially circular shaped. Although other geometric or non-geometric shapes can also be utilized. The first section 14 is designed to have an open center area, and within the open area are at least two cavities 28 that are separated by dividing walls 30, as shown in FIGS. 5 and 6. Extending through the substantial center of the first section 14, along a longitudinal edge of the dividing walls 30 where the walls converge at the center of the first section 14, is a central aperture 32. As shown in FIGS. 1 and 4, the upper perimeter edge 22 can have an upward and inward taper 26, and the lower perimeter edge 24 can have a downward and inward taper 26.

The containing member 12 also includes a second section 46 that functions as a cover or cap on the first section 14, encompassing the cavities 28 with wedges 100 therein. The second section 46, as shown in FIGS. 1, 7 and 8, is preferably shaped as a bifurcated circle 48 with a lower surface 50, a domed outer surface 52 and a lower perimeter edge 54. The second section 46 is typically made of the same material as the first section 14, although there is no requirement for this and the second section 46 could be made of a different material and function with equal efficacy.

In order to provide contact placement, the second section 46 is dimensioned to fit onto and follow along the upper perimeter edge 22 of the first section 14, as shown in FIG. 1. Extending through the substantial center of the second section 46 is a central aperture 56 that is aligned with the central aperture 32 on the first section 14. Additionally, the second section's central aperture 56 can include a slot 58 that extends from the aperture 56 through the second section's domed outer surface 52 to the lower perimeter edge 54. If necessary, an additional bifurcated circular section (not shown) can be placed onto the containing member first section's lower surface 16 to create a containing member with domed surfaces at each end.

The assembly's enclosing member 64, as shown in FIGS. 1, 2, 3, 9 and 10, also includes a first section 68 and a second section 84. The first section 68, as shown in FIGS. 1, 2 and 9, has an upper perimeter edge 70, a domed outer surface 72, an inner surface 74, and an open center area 76. The containing member's first section 14 is wedged into the enclosing member first section's open center area 76, with the first section 68 dimensioned to fit over and enclose the containing member's first section 14. Extending through the substantial center of the first section 68, and aligned with the central apertures 32,56 on the containing member's first section 14 and second section 46, is a central aperture 78.

The enclosing member's second section 84, as shown in FIGS. 1, 2 and 10, is a mirror image of the first section 68, and also has a lower perimeter edge 86, a domed outer surface 88, an inner surface 90, and an open center area 92. Extending through the substantial venter of the second section 84 is a central aperture 94 that is aligned with the central aperture 32,56 on the containing members first section 14 and second section 46, and the aperture 78 on the enclosing members first section 68. The combination of the aligned apertures creates a single central aperture that extends through the entire assembly 10. The single aperture through the assembly 10, either with or without the slot 58 on the containing member's second section 46, facilitates the securement of the assembly 10 to a fishing line, as shown in FIG. 3.

The two sections 68,84 of the enclosing member 64 are both bulbous shaped made of an impact-resistant and impact-absorbing material such as rubber, silicone, plastic, foam or a resilient composite material. When the assembly 10 is used from a vessel, such as a boat the assembly 10 can inadvertently come into contact with the vessel when the assembly is placed into or removed from a body of water. The impact-resistant or impact-absorbing material protects both the assembly and the vessel from damage that can occur as a result of the inadvertent contact.

The wedge 100, is inserted into one of the cavities 28 in the containing member's first section 14. The wedge 100, as shown in FIG. 12, can be made of a variety of materials including plastic, metal or a composite material, or the wedge 100 can be made of or designed to house, a fish attracting substance 106. The function of the wedge determines what material the wedge 100 is made of. For example, when the wedge 100 functions as a weight 104 the wedge is typically made of a heavy, dense metal. The wedge 100 is preferably triangular shaped 102, to correspond to the shape of each cavity 28. The triangular shape of the cavity 28 and wedge 100 allows for the wedge to be press-fit into the cavity. The triangular shape of each provides multiple surfaces that produce friction which maintains the wedge 100 securely within the cavity 28.

In order to increase the functionality of the assembly 10, the wedge 100 can made of an illuminating substance 108 such as a phosphorescent material. The illuminated wedge presents a glowing object within the water that attracts fish and draws them to the baited line within the water.

In order to provide a choice in the amount of weight an assembly has, the weight wedges can be full-sized or variations thereof, such as half-size or quarter-size. When an illuminating substance 108 is utilized, both the containing member 12 and enclosing member 64 most be transparent or translucent. For other applications, both members 12,64 can be any color or combination of colors, such as a camouflage pattern. Also, a dissolving tablet can be placed within hollow wedge 100. As the tablet dissolves, a disturbance that attracts fish occurs in the water around the assembly 10. The disturbance is a fizzing effect that is similar to when a seltzer tablet dissolves in water, or, carbonated crystal can be placed within a wedge 100 to produce a underwater soundwave which also attracts fish.

In order to provide a secure attachment of the enclosing member's first and second sections on and over the containing member 12, a plurality of outward extending tabs 36 can circumvent the substantial midline 38 of the containing member's first section 14. The tabs 36 are located where the perimeter edges 70,86 of the enclosing member's first and second sections 68,84 interface, as shown in FIGS. 1 and 4. Also, as shown in FIG. 1, on the containing member 12 an area above the midline 38 is angled inward and downward 40 from the upper perimeter edge 22 toward the midline 38, and an area below the midland 38 is angled inward and upward 42 from the lower perimeter edge 24 toward the midline 38.

As shown in FIGS. 5 and 6, the containing member's first section 14 can further include multiple openings 34 on the lower surface 16 which facilitate the egress and ingress of water to/from the assembly 10. A single opening 34 extends through the lower surface 16 into a lower inner surface of each cavity 28.

Also, it should be noted that the material the containing member's first section 14 is made of is preferably resilient and deformable to facilitate the placing of the wedge 100 into a cavity 28. And, when a wedge 100 is placed into a cavity 28, a substantial seal is created around the wedge's periphery.

To use the assembly, a person inserts the wedge(s) 100 into a cavity 28 in the containing member's first section 14. When the wedge(s) are secure, within the cavity 28, the containing member's second section is placed on the first section, encompassing the cavities with wedges therein. The enclosing member's first section 68 and second section 84 are then placed on the containing member 12. When the enclosing member's two sections are secured on and over the containing member, a fishing line can be inserted into the single central aperture extending through the assembly 10. When the assembly 10 is securely in place at a desired location on the fishing line, the baited line, along with the assembly, is placed into a body of water and allowed to sink. If desired or required, depending on the use, multiple assemblies 10, each with the same or different type of wedges can be secured to a single fishing line.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A fishing sinker assembly that is used in combination with a fishing pole that maintains and directs an extendable length of fishing line to which bait is attached on a hook at a distal end, wherein said assembly is secured to an end or section of baited fishing line that is placed into a body of water during fishing, wherein said assembly causes the baited fishing line to sink and attracts fish, and is comprised of a containing member including a first section having at least two cavities, and a second section that functions as a cover over the cavities on said first section; and an enclosing member including a first section and a second section which are dimensioned to fit over and enclose said first section and said second section of said containing member, wherein a wedge comprising a weight or a substance that attracts fish is inserted into one of said cavities prior to said enclosing member fitted on and enclosing said containing member and said assembly being secured to the fishing line and placed into a body of water.

2. The fishing sinker assembly as specified in claim 1 wherein said containing member is made of a material selected from the group consisting of plastic, metal or a composite material.

3. The fishing sinker assembly as specified in claim 1 wherein said containing member first section's at least two cavities are each triangular shaped.

4. The fishing sinker assembly as specified in claim 1 wherein said containing member's second section is shaped as a bifurcated circle with a domed outer surface.

5. The fishing sinker assembly as specified in claim 1 wherein said enclosing member's first section and second section are made of a material that is selected from the group consisting of rubber, silicone, plastic, foam, or a composite material.

6. The fishing sinker assembly as specified in claim 1 wherein said wedge having a triangular shape that is dimensioned to allow said wedge to be press-fit into one of said cavities, wherein the multiple surfaces of the triangular shape provide friction to create a secure press-fit of said wedge into said cavity.

7. The fishing sinker assembly as specified in claim 6 wherein said wedge is made of a material selected from the group consisting of metal, plastic, or a composite material.

8. The fishing sinker assembly as specified in claim 1 further comprising a central aperture through said containing member's first section and second section, and through said enclosing member's first section and second section, wherein said apertures are aligned with each other such that a single aperture that extends entirely through said assembly, thereby providing an aperture through which a fishing line is inserted to secure said assembly to the line.

9. The fishing sinker assembly as specified in claim 8 wherein said containing member second section's central aperture further comprises a slot that extends from said aperture through said second section's domed outer surface to the lower perimeter edge, wherein the slot facilitates the securement of a fishing line to said assembly.

10. The fishing sinker assembly as specified in claim 1 wherein said wedge further comprising an illuminated substance that presents a glowing object underwater, thereby attracting fish to said assembly.

11. A fishing sinker assembly that is used in combination with a fishing pole that maintains and directs an extendable length of fishing line to which bait is attached on a hook at a distal end, wherein said assembly is secured to an end or section of baited fishing line that is placed into a body of water during fishing, wherein said assembly causes the baited fishing line to sink to an optimal depth, and attracts fish to bait on the fishing line, wherein said assembly is comprised of:
a) a containing member including:
1) a first section having a lower surface, an outer surface, an inner surface, an upper perimeter edge, a lower perimeter edge, at least two triangular shaped cavities separated by dividing walls located within said first section, and a central aperture that extends through the substantial center of said first section along a longitudinal edge of the dividing walls where the walls converge at the center of said first section,
2) a second section that is shaped as a bifurcated circle and is dimensioned to fit over said first section, along said first section's upper perimeter edge, wherein said second section functions as a cover over said cavities, wherein said second section having a lower surface, a domed outer surface, a lower perimeter edge, and a central aperture that extends through the substantial center of said second section and is aligned with the central aperture on said first section,
b) an enclosing member including:
1) a first section having an upper perimeter edge, a domed outer surface, an inner surface, and a central aperture that extends through the substantial center of said first section and is aligned with the central apertures on said containing member's first section and second section, wherein said containing member's first section is inserted into said enclosing member first section's open central area with said enclosing member's first section dimensioned to fit over and enclose said containing member's first section to a substantial midpoint on said containing member when said containing member's first section and second section are interfaced,
2) a second section having a lower perimeter edge, a domed outer surface, an inner surface, and a central aperture that extends through the substantial center of said second section, and is aligned with the central apertures on said first section and said containing member's first section and second section, wherein the combined aligned central apertures create a single aperture that extends entirely through said assembly to facilitate the securement of said assembly to a fishing line, and
c) at least two wedges that are triangular shaped and dimensioned such that one wedge is inserted and maintained by press-fit within one of said cavities in said containing member, wherein each said wedge functions as a weight to force said assembly to sink below a surface of a body of water, or as a substance that attracts fish, wherein said wedge is placed within a cavity said containing member's second section is placed onto said containing member's first section, over said cavities with wedges therein; said enclosing member's first section and second section are placed onto said containing member, said assembly is secured to a baited fishing line; and said baited line with secured assembly is placed into a body of water and allowed to sink to an optimal depth.

12. The fishing sinker assembly as specified in claim 11 wherein said containing member is made of a material selected from the group consisting of plastic, metal or a composite material.

13. The fishing sinker assembly as specified in claim 11 wherein the triangular shape of each said cavity in concert with the corresponding triangular shape of each said wedge presents multiple surfaces which produce friction that creates a secure press-fit of said wedge into said cavity.

14. The fishing sinker assembly as specified in claim 11 wherein said cavities are equi-distantly positioned around said central aperture in said containing member's first section.

15. The fishing sinker assembly as specified in claim 11 wherein said enclosing member's first section and second section are made of an impact-resistant or impact-absorbing material, wherein said assembly inadvertently comes into contact with a vessel when placed in or removed from a body of water, wherein the impact-resistant or impact-absorbing material protects both the vessel and said assembly from damage as a result of the inadvertent contact, wherein the material is selected from the group consisting of rubber, silicone, foam or a composite material,

16. The fishing sinker assembly as specified in claim 15 wherein the material that said containing member's first section and second section are made of is resilient and deformable to facilitate the inserting of said wedge into said cavity.

17. The fishing sinker assembly as specified in claim 16 wherein when said wedge is inserted into said cavity, a substantial seal is created around said wedge's periphery.

18. The fishing sinker assembly as specified in claim 11 wherein said containing member's first section further comprising a plurality of outward extending tabs that circumvent the substantial midline of said first section, wherein the tabs are located where the perimeter edges of said enclosing member's first section and second section interface, thereby providing securement of said enclosing member to said containing member.

19. The fishing sinker assembly as specified in claim 11 wherein said containing member's first section upper perimeter edge further comprises and upward and inward taper, and said lower perimeter edge further comprises a downward and inward taper.

20. The fishing sinker assembly as specified in claim 11 wherein said containing member further comprises an area above the substantial midline angled inward and downward from the upper perimeter edge towards the midline, and an area below the substantial midline angled inward and upward from the lower perimeter edge toward the midline.

21. The fishing sinker assembly as specified in claim 11 wherein said wedge further comprising an illuminated substance that presents a glowing object underwater, thereby attracting fish to said assembly.

22. The fishing sinker assembly as specified in claim 11 wherein said containing member's first section further comprising multiple openings on the lower surface, with one opening extending into a lower inner surface of each cavity.

23. The fishing sinker assembly as specified in claim 11 wherein said containing member's second section central aperture further comprises a slot that extends from said aperture through said second section's domed outer surface to the lower perimeter edge, wherein the slot facilitates the securement of a fishing line to said assembly.
